(19) United States
(12) Patent Application Publication
(10) Pub. No.: US 2023/0302491 A1
(43) Pub. Date: Sep. 28, 2023

(54) METHOD FOR THE IN-SITU ENCAPSULATION AND/OR INSULATION OF PIPING

(71) Applicants: DOW SILICONES CORPORATION, Midland, MI (US); DOW GLOBAL TECHNOLOGIES LLC, Midland, MI (US)

(72) Inventors: Timothy MORLEY, Midland, MI (US); Kshitish PATANKAR, Midland, MI (US); Bradley W. TUFT, Midland, MI (US); Thomas J. PARSONS, Midland, MI (US); David SHAWL, Midland, MI (US); Kaila M. MATTSON, Midland, MI (US); Veronika IRKHA, Midland, MI (US); Torrey CLARK, Midland, MI (US); Dimitris KATSOULIS, Midland, MI (US); Mark F. SONNENSCHEIN, Midland, MI (US)

(21) Appl. No.: 17/800,209

(22) PCT Filed: Feb. 18, 2021
(86) PCT No.: PCT/US2021/018464

§ 371 Date: Aug. 16, 2022

Related U.S. Application Data
(60) Provisional application No. 62/978,482, filed on Feb. 19, 2020.

(51) Int. Cl. B05D 7/14; F16L 59/15; B05D 5/00; B05D 3/10

(52) U.S. Cl. CPC B05D 7/146; B05D 3/108; B05D 5/005; F16L 59/15; B05D 2254/02; B05D 2518/10; B05D 2601/22

(57) ABSTRACT

This disclosure relates to a method for the in-situ encapsulation and/or insulation of piping using silicone-based compositions such as liquid silicone rubber materials and/or silicone foams. The method is useful for encapsulation and/or insulation of underground piping, particularly underground piping carrying high temperature (e.g., >120° C.) fluids, such as steam. The in-situ encapsulation and/or insulation may be done by inserting a hose into a pipe cavity so that a first end of the hose is remotely positioned next to the pipe and a second end of the hose is attached to a pumping system. A silicone composition is pumped through the hose and into the cavity surrounding from the remote first end of the tubing at a first predefined rate, and the hose is gradually withdrawn from the cavity at a second predefined rate. The silicone material is allowed to cure and become rigid, thereby encapsulating and/or insulating the pipe.

This disclosure relates to a method for the in-situ encapsulation and/or insulation of piping, such as underground piping, particularly underground piping carrying high temperature (e.g. greater than (>) 120° C.) fluids, such as steam using silicone-based compositions such as liquid silicone rubber materials and/or silicone foams.

It is well known that piping can be utilised to transport hot fluids such as hot water, and other heat and energy source materials, to, from and between buildings especially in urban and industrial areas. Many fluids transported in this manner e.g. steam can be transported at very high temperatures e.g. at least 120° C., but often even >150° C. Typically, the hotter the fluid being transported, the increasingly more important it is to insulate the exterior of the piping to minimise heat loss, especially if the piping is constructed from a good thermal conductor such as a metal. For example, in the case of transporting steam through pipes underground and/or through building conduits, a large proportion of older pipework (e.g. >30 years) is metallic e.g. steel based. Historically such pipes were originally insulated prior to or during installation using rigid organic plastic foams applied around the metal pipes in underground cavities and/or through conduit piping. For example, the metal pipe was laid inside of either concrete or tile conduit pipe.

Much of this “historic” insulation has failed, disintegrated, cracked and/or become significantly less efficient due to its age, leading to significant heat loss, condensation (in the case of steam pipes etc.) and/or even leakages. As a consequence, aged heating of the like systems are becoming both increasingly expensive to run and in need of renovation. However, to further complicate issues it is not really feasible to undertake remedial work such as to dig up the surrounding area to gain access to underground pipework or to knock down walls and/or take up flooring in buildings to gain access to conduit pipes to re provide re-insulation because of the disruption it would cause and because of the shear extent of the pipework in need of such renovative activities.

Processes for re-insulating and protecting underground pipes in situ, without disrupting supply of hot fluids through the pipes etc. have been proposed. For example, processes for applying polyurethane (PU) or polyisocyanurate (PIR) type foamed materials that lend themselves to filling such cavities due to their high expansion rates and suitable thermal conductivity have been proposed using a variety of processes including using a retractable hose that can be inserted into a cavity to be filled and slowly retracted as the cavity around the pipe is filled. However, whilst suitable for the insulation of pipes transporting lower temperature fluids (e.g. less than (<) 110° C.), PU and PIR based insulation is not generally suited for insulating pipes used for the transport of high temperature fluids, e.g. steam, as these may be transported at much higher temperatures e.g. equal to or greater than (≥) 250° C. for which PU and PIR materials are unsuitable as insulating materials over long periods of time as they degrade and cannot withstand long term high temperature aging.

Given their heat stability properties room temperature vulcanization (RTV) silicone foams may seem suitable alternatives for high temperature insulation situations. However, they are almost exclusively chemically blown using a dehydro-condensation reaction between silicone hydride and hydroxyl-functional components which generate hydrogen gas. The hydrogen gas is then relied upon to function as a “chemical” blowing agent as it was prepared by way of a chemical reaction. However, given the explosive nature of hydrogen gas and the high temperature of the fluids being transported through the pipes having the potential to lead to explosions, the use of chemically blown silicone foams was deemed too dangerous.

Accordingly, it is an object of the present invention to provide a method for encapsulating and/or insulating underground, pipes in situ that can overcome the problems inherent in previous systems.

There is provided a method for in-situ encapsulation and/or insulation of a restricted access pipe by gaining access to a pipe cavity in which a pipe to be insulted is situated, inserting a hose into the cavity so that a first end of the hose is remotely positioned next to the pipe and a second end of the hose is attached to a pumping system wherein a silicone composition is pumped through the hose and into the cavity surrounding from the remote first end of the tubing at a first predefined rate the hose is gradually withdrawn from the cavity at a second predefined rate and the silicone material is allowed to cure and become rigid, thereby encapsulating and/or insulating the pipe.

Access may be gained into the cavity surrounding the pipe by any appropriate means such as a drill, torch or jack-hammer. Once the cavity has been opened the hose may be inserted along the length of the cavity in any suitable manner e.g. using a suitable carriage. The hose may then be positioned next to the pipe and a second end of the hose is attached to the pumping system. The silicone composition is then pumped through the system and hose and directed around the targeted hot pipe or in the cavity region around same. As the cavity fills or the pipe is thoroughly coated, the hose is gradually withdrawn and the coating and/or insulation in the cavity is left to cure.

A preferred embodiment of the present invention wherein the steam pipe is encased in conduit and has an annular space between the pipe and the conduit provides for the following steps: creating at least one hole in the ground; lowering a drill into the hole; drilling a hole in the conduit; inserting tubing into the hole in the conduit so that a first end of the tubing is positioned next to the pipe and a second end of the tubing is attached to a pumping means; pumping the foam through the tubing so that the foam fills the annular space around the pipe; removing the tubing; and allowing the foam to cure and become rigid thereby functioning as insulation.

If deemed appropriate a number of holes may be made in the conduit and distances along a conduit containing a pipe to be insulated so that the operation of injecting the insulating foam over the length of the steel steam pipe can be performed in a series of operations, especially if the conduit is not straight.

In one embodiment the first end of the hose may be fixed to a suitable carriage for transport to the end of the pipe to be coated/insulated, enabling the hose to be gradually withdrawn from the cavity as the cavity is filled or the pipe coated. The carriage may comprise a robotic means adapted to be able to hold and direct the dispensing means at and around the pipe or into the cavity. Said carriage may also comprise a camera to enable observation of the coating of the pipe and/or filling of the cavity with insulation material. The camera may also be utilised to enable an operator to control the robotic means and ensure the pipe is being correctly/fully coated and/or the cavity fully filled.

The hose may be of any suitable length and as such the speed of flow through the hose, for example will need to be controlled to reach the point of delivery in a suitably well mixed form so as to be curable upon application onto the pipe or into the cavity and to avoid blockages within the hose due to premature cure. For example, the hose may be from 15 m to 100 m in length or even longer, if appropriate.

One advantage of the current disclosure is that the process may be undertaken without removing any existing insulation i.e. where the original insulation is broken or split or the like this can be sealed by the silicone compositions herein. For example, a silicone coating may be provided on to the pipe to coat and seal the previous insulation and then the silicone foam may be introduced to insulate the cavity once the coating has at least partially, preferable completely cured.

Silicone materials have the advantage of possessing inherent stability towards heat due to the structure of their polymers and lend themselves well to an application where resistance to water and other associated media is required as well as longevity in a high heat application such as a coating or protective barrier for underground steam pipes. The silicone materials that would be suitable for this application and lend themselves to this application technique include hydrosilylation cured liquid silicone rubbers (LSRs), liquid silicone rubbers filled with glass microspheres (GSLSRs), and silicone foamed materials using physical blowing agents either with or without glass microspheres.

In the case of the present method the silicone composition utilised is a hydrosilylation cured composition which may have the following composition
i) an organopolysiloxane having at least two silicon-bonded ethylenically unsaturated groups per molecule;
ii) an organohydrogensiloxane having at least two silicon-bonded hydrogen atoms per molecule;
iii) a hydrosilylation catalyst;
iv) a physical blowing agent when the composition is to be made into a foam; and optionally
(v) glass microspheres.

The silicone composition can be cured to a silicone elastomeric material to form an encapsulating layer around the pipe when no blowing agent is used or can generate a foamed silicone elastomer (referred to herein as a or the “foam,” or “foamed elastomer,”), with both being alternative reaction products of the composition. Each reaction product may also be formed in the presence of one or more optional additives. Such additives, if utilized, may be inert to, or reactive with, other components of the composition.

In the case of the foamed elastomer products described herein the only blowing agent used to form the foam is physical blowing agent (iv). It is an important reason for being able to use the silicone foam for this type of application that standard chemical blowing agents used with silicone foams which generate hydrogen during a chemical reaction are avoided given the temperature of the pipes being insulated. In various embodiments, component (iv) is classified as a physical blowing agent, such as a gas or is a liquid or solid material which undergoes a phase change in the proximity of the temperature of foam formation or application.

As used herein, the term “ambient temperature” or “room temperature” refers to a temperature between about 20° C. and about 30° C. Usually, room temperature ranges from about 20° C. to about 25° C. The term “ambient pressure” or “atmospheric pressure” refers to a pressure of about 101 kPa.

All viscosity measurements referred to herein were measured at 25° C. unless otherwise indicated. Viscosity can be determined via methods understood in the art. The following abbreviations have these meanings herein: “Me” means methyl, “Et” means ethyl, “Pr” means propyl, “Bu” means butyl, “g” means grams, and “ppm” means parts per million.

“Hydrocarbyl” means a monovalent hydrocarbon group which may be substituted or unsubstituted. Specific examples of hydrocarbyl groups include alkyl groups, alkenyl groups, alkynyl groups, aryl groups, aralkyl groups, etc.

“Alkyl” means an acyclic, branched or unbranched, saturated monovalent hydrocarbon group. Alkyl is exemplified by, but not limited to, Me, Et, Pr (e.g. iso-Pr and/or n-Pr), Bu (e.g. iso-Bu, n-Bu, tert-Bu, and/or sec-Bu), pentyl (e.g. iso-pentyl, neopentyl, and/or tert-pentyl), hexyl, heptyl, octyl, nonyl, decyl, undecyl, and dodecyl as well as branched saturated monovalent hydrocarbon groups of 6-12 carbon atoms. Alkyl groups may have 1-30, alternatively 1-24, alternatively 1-20, alternatively 1-12, alternatively 1-10, and alternatively 1-6, carbon atoms.

“Alkenyl” means an acyclic, branched or unbranched, monovalent hydrocarbon group having one or more carbon-carbon double bonds. Alkenyl is exemplified by, but not limited to, vinyl, allyl, methallyl, propenyl, and hexenyl. Alkenyl groups may have 2-30, alternatively 2-24, alternatively 2-20, alternatively 2-12, alternatively 2-10, and alternatively 2-6, carbon atoms.

“Alkynyl” means an acyclic, branched or unbranched, monovalent hydrocarbon group having one or more carbon-carbon triple bonds. Alkynyl is exemplified by, but not limited to, ethynyl, propynyl, and butynyl. Alkynyl groups may have 2-30, alternatively 2-24, alternatively 2-20, alternatively 2-12, alternatively 2-10, and alternatively 2-6, carbon atoms.

“Aryl” means a cyclic, fully unsaturated, hydrocarbon group. Aryl is exemplified by, but not limited to, cyclopentadienyl, phenyl, anthracenyl, and naphthyl. Monocyclic aryl groups may have 5-9, alternatively 6-7, and alternatively 5-6, carbon atoms. Polycyclic aryl groups may have 10-17, alternatively 10-14, and alternatively 12-14, carbon atoms.

“Aralkyl” means an alkyl group having a pendant and/or terminal aryl group or an aryl group having a pendant alkyl group. Exemplary aralkyl groups include tolyl, xylyl, mesityl, benzyl, phenylethyl, phenyl propyl, and phenyl butyl.

“Alkenylene” means an acyclic, branched or unbranched, divalent hydrocarbon group having one or more carbon-carbon double bonds. “Alkylene” means an acyclic, branched or unbranched, saturated divalent hydrocarbon group. “Alkynylene” means an acyclic, branched or unbranched, divalent hydrocarbon group having one or more carbon-carbon triple bonds. “Arylene” means a cyclic, fully unsaturated, divalent hydrocarbon group.

“Carbocycle” and “carbocyclic” each mean a hydrocarbon ring. Carbocycles may be monocyclic or alternatively may be fused, bridged, or spiro polycyclic rings. Monocyclic carbocycles may have 3-9, alternatively 4-7, and alternatively 5-6, carbon atoms. Polycyclic carbocycles may have 7-17, alternatively 7-14, and alternatively 9-10, carbon atoms. Carbocycles may be saturated or partially unsaturated.

“Cycloalkyl” means a saturated carbocycle. Monocyclic cycloalkyl groups are exemplified by cyclobutyl, cyclopentyl, and cyclohexyl. “Cycloalkylene” means a divalent saturated carbocycle.

The term “substituted” as used in relation to another group, e.g. a hydrocarbyl group, means, unless indicated otherwise, one or more hydrogen atoms in the hydrocarbyl group has been replaced with another substituent. Examples of such substituents include, for example, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amines, aminofunctional groups, amido-functional groups, and cyano-functional groups; sulphur atoms; and sulphur atom containing groups such as mercapto groups.

M, D, T and Q units are generally represented as RᵤSiO(₄₋ᵤ)_{/2}, where u is 3, 2, 1, and 0 for M, D, T, and Q, respectively, and R is an independently selected hydrocarbyl group. The M, D, T, Q designate one (Mono), two (Di), three (Tri), or four (Quad) oxygen atoms covalently bonded to a silicon atom that is linked into the rest of the molecular structure.

### Component (i)

Component (i) is an organopolysiloxane having at least two silicon-bonded ethylenically unsaturated groups per molecule. Component (i) may be any unsaturated organopolysiloxane based compound having at least two aliphatically unsaturated groups. In various embodiments, component (i) has at least three silicon-bonded ethylenically unsaturated groups per molecule. In certain embodiments, component (i) comprises a siloxane. In other embodiments, component (i) comprises a silicone-organic hybrid. Various embodiments and examples of component (i) are disclosed below.

The aliphatically unsaturated groups of component (i) may be terminal, pendent, or in both locations in component (i). For example, the aliphatically unsaturated group may be an alkenyl group and/or an alkynyl group. Alkenyl groups are exemplified by, but not limited to, vinyl, allyl, propenyl, and hexenyl. Alkynyl is exemplified by, but not limited to, ethynyl, propynyl, and butynyl.

In certain embodiments, component (i) comprises an organopolysiloxane having multiple repeating groups of the following average formula:

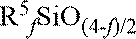

wherein each R⁵ is an independently selected substituted or unsubstituted hydrocarbyl group with the proviso that in each molecule, at least two R⁵ groups are aliphatically unsaturated groups, and wherein f is selected such that zero is less than f which in turn is less than or equal to 3.2 ( 0 < f ≤ 3.2).

The average formula above for the organopolysiloxane may be alternatively written in the form of a molar fraction as

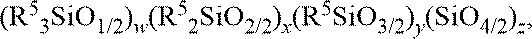

where R⁵ and its proviso is defined above, and w, x, y, and z are independently from ≥0 to ≤1, with the proviso that w+x+y+z=1. One of skill in the art understands how such M, D, T, and Q units and their molar fractions influence subscript f in the average formula above. T and Q units, indicated by subscripts y and z, are typically present in silicone resins, whereas D units, indicated by subscript x, are typically present in silicone polymers (and may also be present in silicone resins).

Each R⁵ is independently selected, as introduced above, and may be linear, branched, cyclic, or combinations thereof. Cyclic hydrocarbyl groups encompass aryl groups as well as saturated or non-conjugated cyclic groups. Aryl groups may be monocyclic or polycyclic. Linear and branched hydrocarbyl groups may independently be saturated or unsaturated. One example of a combination of a linear and cyclic hydrocarbyl group is an aralkyl group. Examples of substituted and unsubstituted hydrocarbyl groups are introduced above relative to R. Examples of aliphatically unsaturated group(s) are also introduced above.

In certain embodiments, the organopolysiloxane is substantially linear, alternatively is linear. In these embodiments, the substantially linear organopolysiloxane may have the average formula:

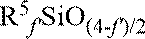

wherein each R⁵ and its proviso are defined above, and wherein f′ is selected such that 1.9 ≤ f′ ≤ 2.2 and having terminal groups of the structure R⁵₃SiO_{½.}

In these embodiments, at a temperature of 25° C., the substantially linear organopolysiloxane is typically a flowable liquid or is in the form of an uncured siloxane gum. Generally, the substantially linear organopolysiloxane has a viscosity of from 10 to 30,000,000 mPa.s, alternatively from 10 to 10,000,000 mPa.s, alternatively from 100 to 1,000,000 mPa.s, alternatively from 100 to 100,000 mPa.s, at 25° C. Viscosity may be measured at 25° C. via a Brookfield LV DV-E viscometer, as understood in the art. However, because of the difficulty in measuring viscosity of highly viscous fluids such as silicone gums, the gums may alternatively be described by way of their Williams plasticity values in accordance with ASTM D-926-08 rather than by viscosity. A polydiorganosiloxane gum (i) has a viscosity resulting in a Williams’s plasticity of at least 30 mm/100 measured in accordance with ASTM D-926-08, alternatively at least 50 mm/100 measured in accordance with ASTM D-926-08, alternatively at least 100 mm/100 measured in accordance with ASTM D-926-08, alternatively from 100 mm/100 to 300 mm/100.

In specific embodiments in which the organopolysiloxane is substantially linear or linear, the organopolysiloxane may have the average formula:

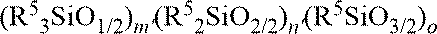

wherein each R⁵ is independently selected and defined above (including the proviso that in each molecule, at least two R⁵ groups are aliphatically unsaturated groups), and m′≥2, n′≥2, and o≥0. In specific embodiments, m′ is from 2 to 10, alternatively from 2 to 8, alternatively from 2 to 6. In these or other embodiments, n′ is from 2 to 1,000, alternatively from 2 to 500, alternatively from 2 to 200. In these or other embodiments, o is from 0 to 500, alternatively from 0 to 200, alternatively from 0 to 100.

When the organopolysiloxane is substantially linear, alternatively is linear, the silicon-bonded aliphatically unsaturated groups may be pendent, terminal or in both pendent and terminal locations. As a specific example of the organopolysiloxane having pendant silicon-bonded aliphatically unsaturated groups, the organopolysiloxane may have the average formula:

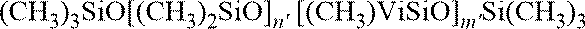

where n′ and m′ are defined above, and Vi indicates a vinyl group. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Alternatively, as a specific example of the organopolysiloxane having terminal silicon-bonded aliphatically unsaturated groups, the organopolysiloxane may have the average formula:

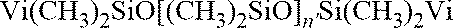

where n′ and Vi are defined above. The dimethyl polysiloxane terminated with silicon-bonded vinyl groups may be utilized alone or in combination with the dimethyl, methylvinyl polysiloxane disclosed immediately above. With regard to this average formula, one of skill in the art knows that any methyl group may be replaced with a vinyl or a substituted or unsubstituted hydrocarbyl group, and any vinyl group may be replaced with any ethylenically unsaturated group, so long as at least two aliphatically unsaturated groups are present per molecule. Because the at least two silicon-bonded aliphatically unsaturated groups may be both pendent and terminal, component (i) may have the average formula:

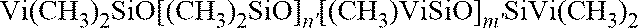

where n′, m′ and Vi are defined above.

The substantially linear organopolysiloxane can be exemplified by a dimethylpolysiloxane capped at both molecular terminals with dimethylvinylsiloxy groups, a methylphenylpolysiloxane capped at both molecular terminals with dimethylvinylsiloxy groups, a copolymer of a methylphenylsiloxane and dimethylsiloxane capped at both molecular terminals with dimethylvinylsiloxy groups, a copolymer of a methylvinylsiloxane and a methylphenylsiloxane capped at both molecular terminals with dimethylvinylsiloxy groups, a copolymer of a methylvinylsiloxane and diphenylsiloxane capped at both molecular terminals with dimethylvinylsiloxy groups, a copolymer of a methylvinylsiloxane, methylphenylsiloxane, and dimethylsiloxane capped at both molecular terminals with dimethylvinylsiloxy groups, a copolymer of a methylvinylsiloxane and a methylphenylsiloxane capped at both molecular terminals with trimethylsiloxy groups, a copolymer of a methylvinylsiloxane and diphenylsiloxane capped at both molecular terminals with trimethylsiloxy groups, and a copolymer of a methylvinylsiloxane, methylphenylsiloxane, and a dimethylsiloxane capped at both molecular terminals with trimethylsiloxy groups.

In these or other embodiments, component (i) may be a resinous organopolysiloxane. In these embodiments, the resinous organopolysiloxane may have the average formula:

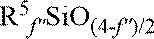

wherein each R⁵ and its provisos are defined above, and wherein f″ is selected such that 0.5 ≤ f″ ≤ 1.7.

The resinous organopolysiloxane has a branched or a three-dimensional network molecular structure. At 25° C., the resinous organopolysiloxane may be in a liquid or in a solid form, optionally dispersed in a carrier, which may solubilize and/or disperse the resinous organopolysiloxane therein.

In specific embodiments, the resinous organopolysiloxane may be exemplified by an organopolysiloxane that comprises only T units, an organopolysiloxane that comprises T units in combination with other siloxy units (e.g. M, D, and/or Q siloxy units), or an organopolysiloxane comprising Q units in combination with other siloxy units (i.e., M, D, and/or T siloxy units). Typically, the resinous organopolysiloxane comprises T and/or Q units. A specific example of the resinous organopolysiloxane is a vinyl-terminated silsesquioxane.

The organopolysiloxane may comprise a combination or mixture of different organopolysiloxanes, including those of different structures. In certain embodiments, component (i) comprises one or more linear organopolysiloxanes as a majority component.

### Component (ii)

Component (ii) includes at least two silicon-bonded hydrogen atoms per molecule. In various embodiments, component (ii) has at least three silicon-bonded hydrogen atoms per molecule. Component (ii) can be linear, branched, cyclic, resinous, or have a combination of such structures. In acyclic polysilanes and polysiloxanes, the silicon-bonded hydrogen atoms can be located at terminal, pendant, or at both terminal and pendant positions. Cyclosilanes and cyclosiloxanes typically have from 3 to 12 silicon atoms, alternatively from 3 to 10 silicon atoms, alternatively from 3 to 4 silicon atoms.

In certain embodiments, component (ii) is of formula R⁸₄_ₛSiHₛ, where R⁸ is independently selected and may be any silicon-bonded group, and s is selected such that 1 ≤ s ≤ 4. Typically, s is 1, 2, or 3, alternatively 1 or 2. Each R⁸ is typically independently a substituted or unsubstituted hydrocarbyl group. However, R⁸ can be any silicon-bonded group so long as component (ii) is still capable of undergoing hydrosilylation via its silicon-bonded hydrogen atoms. For example, R⁸ can be a halogen. When component (ii) is a silane compound, component (ii) can be a monosilane, disilane, trisilane, or polysilane.

In these or other embodiments, component (ii) may be an organosilicon compound of formula: H_{g′}R⁹_{3-g′},Si—R¹⁰—SiR⁹₂H, wherein each R⁹ is an independently selected substituted or unsubstituted hydrocarbyl group, g′ is 0 or 1, and R¹⁰ is a divalent linking group. R¹⁰ may be a siloxane chain (including, for example, —R⁹₂SiO—, —R⁹HSiO—, and/or —H₂SiO— D siloxy units) or may be a divalent hydrocarbon group. Typically, the divalent hydrocarbon group is free of aliphatic unsaturation. The divalent hydrocarbon group may be linear, cyclic, branched, aromatic, etc., or may have combinations of such structures.

In these or other embodiments, component (ii) comprises an organohydrogensiloxane, which can be a disiloxane, trisiloxane, or polysiloxane. Examples of organohydrogensiloxanes suitable for use as component (ii) include, but are not limited to, siloxanes having the following formulae: PhSi(OSiMe₂H)₃, Si(OSiMe₂H)₄, MeSi(OSiMe₂H)₃, and Ph₂Si(OSiMe₂H)₂, wherein Me is methyl, and Ph is phenyl. Additional examples of organohydrogensiloxanes that are suitable for purposes of component (ii) include 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), and a dimethylhydrogensiloxy-terminated poly(methylhydrogensiloxane).

When component (ii) comprises an organohydrogensiloxane, component (ii) may comprise any combination of M, D, T and/or Q siloxy units, so long as component (ii) includes at least two silicon-bonded hydrogen atoms. These siloxy units can be combined in various manners to form cyclic, linear, branched and/or resinous (three-dimensional networked) structures. Component (ii) may be monomeric, polymeric, oligomeric, linear, branched, cyclic, and/or resinous depending on the selection of M, D, T, and/or Q units.

Because component (ii) includes at least two silicon-bonded hydrogen atoms, with reference to the siloxy units set forth above, component (ii) may comprise any of the following siloxy units including silicon-bonded hydrogen atoms, optionally in combination with siloxy units which do not include any silicon-bonded hydrogen atoms: (R⁹₂HSiO_{½}), (R⁹H₂SiO_{½}), (H₃SiO_{½}), (R⁹HSiO_{2/2}), (H₂SiO_{2/2}), and/or (HSiO_{3/2}), where R⁹ is independently selected and defined above.

In specific embodiments, for example when component (ii) is linear, component (ii) may have the average formula:

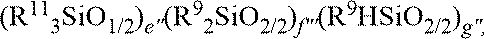

wherein each R¹¹ is independently hydrogen or R⁹, each R⁹ is independently selected and defined above, and e″ ≥2, f‴ ≥0, and g″ ≥2. In specific embodiments, e″ is from 2 to 10, alternatively from 2 to 8, alternatively from 2 to 6. In these or other embodiments, f‴ is from 0 to 1,000, alternatively from 1 to 500, alternatively from 1 to 200. In these or other embodiments, g″ is from 2 to 500, alternatively from 2 to 200, alternatively from 2 to 100.

In one embodiment, component (ii) is linear and includes two or more pendent silicon-bonded hydrogen atoms. In these embodiments, component (ii) may be a dimethyl, methyl-hydrogen polysiloxane having the average formula;

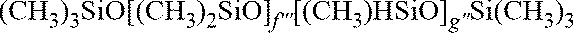

where f‴ and g″ are defined above.

In these or other embodiments, component (ii) is linear and includes terminal silicon-bonded hydrogen atoms. In these embodiments, component (ii) may be an SiH terminal dimethyl polysiloxane having the average formula:

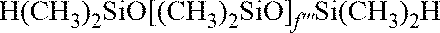

where f‴ is as defined above. The SiH terminal dimethyl polysiloxane may be utilized alone or in combination with the dimethyl, methyl-hydrogen polysiloxane disclosed immediately above. Further, the SiH terminal dimethyl polysiloxane may have one trimethylsiloxy terminal such that the SiH terminal dimethyl polysiloxane may have only one silicon-bonded hydrogen atom. Alternatively, component (ii) may include both pendent and terminal silicon-bonded hydrogen atoms.

In these embodiments, at a temperature of 25° C., the substantially linear organohydrogenpolysiloxane is typically a flowable liquid or is in the form of an uncured rubber. Generally, the substantially linear organohydrogenpolysiloxane has a viscosity of from 10 to 30,000,000 mPa.s, alternatively from 10 to 10,000,000 mPa.s, alternatively from 100 to 1,000,000 mPa.s, alternatively from 100 to 100,000 mPa.s, at 25° C. Viscosity may be measured at 25° C. via a Brookfield LV DV-E viscometer, as understood in the art. As discussed above high viscosity gums may be defined in terms of their Williams plasticity values as opposed to by way of viscosity.

In certain embodiments, component (ii) may have one of the following average formulas:

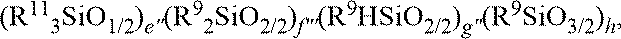

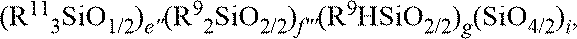

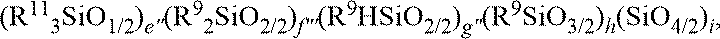

wherein each R¹¹ and R⁹ is independently selected and defined above, e″, f‴, and g″ are defined above, and h≥0, and i is ≥0.

Some of the average formulas above for component (ii) are resinous when component (ii) includes T siloxy units (indicated by subscript h) and/or Q siloxy units (indicated by subscript i). When component (ii) is resinous, component (ii) is typically a copolymer including T siloxy units and/or Q siloxy units, in combination with M siloxy units and/or D siloxy units. For example, the organohydrogenpolysiloxane resin can be a DT resin, an MT resin, an MDT resin, a DTQ resin, an MTQ resin, an MDTQ resin, a DQ resin, an MQ resin, a DTQ resin, an MTQ resin, or an MDQ resin.

In various embodiments in which component (ii) is resinous, or comprises an organopolysiloxane resin, component (ii) typically has the formula:

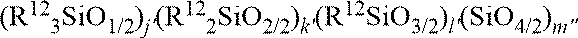

wherein each R¹² independently is H or a substituted or unsubstituted hydrocarbyl group, with the proviso that in one molecule, at least one R¹² is H; and wherein 0≤j′≤1; 0≤k′≤1;0≤1′≤1;and 0≤m″≤1; with the proviso that j′+k′+l′+m″=1.

In certain embodiments, component (ii) may comprise an alkylhydrogen cyclosiloxane or an alkylhydrogen dialkyl cyclosiloxane copolymer, represented in general by the formula (R¹²₂SiO)_{r′}(R^{l2}HSiO)_{s′}, where R¹² is independently selected and defined above, and where r′ is an integer from 0-7 and s′ is an integer from 3-10. Specific examples of suitable organohydrogensiloxanes of this type include (OSiMeH)₄, (OSiMeH)₃(OSiMeC₆H₁₃), (OSiMeH)₂(OSiMeC₆H₁₃)₂, and (OSiMeH)(OSiMeC₆H₁₃)₃, where Me represents methyl (—CH₃). Component (ii) can be a single silicon hydride compound or a combination comprising two or more different silicon hydride compounds.

The composition may comprise components (i) and (ii) in varying amounts or ratios contingent on desired properties of the composition and foams formed therefrom. In various embodiments, the composition comprises components (i) and (ii) in an amount to provide a mole ratio of silicon-bonded hydrogen atoms to aliphatically unsaturated groups of from 0.3:1 to 5:1, alternatively from 0.6:1 to 3:1. The alkenyl and/or alkynyl content of component (i) as well as the silicon-bonded hydrogen (Si—H) content of component (ii) were determined using quantitative infra-red analysis in accordance with ASTM E168.

### Component (iii)

The hydrosilylation (or addition) reaction, e.g. between Si—H and ethylenically unsaturated groups, takes place in the presence of the hydrosilylation catalyst (hereinafter the “catalyst”). The catalyst may be conventional to the art. For example, the catalyst may be a platinum group metal-containing catalyst. By “platinum group” it is meant ruthenium, rhodium, palladium, osmium, iridium and platinum and complexes thereof.

The catalyst can be platinum metal, platinum metal deposited on a carrier, such as silica gel or powdered charcoal, or a compound or complex of a platinum group metal. Typical catalysts include chloroplatinic acid, either in hexahydrate form or anhydrous form, and/or a platinum-containing catalyst which is obtained by a method comprising reacting chloroplatinic acid with an aliphatically unsaturated organosilicon compound, such as divinyltetramethyldisiloxane, or alkene-platinum-silyl complexes as described in US Pat. No. 6,605,734. An example is: (COD)Pt(SiMeCI₂)₂ where “COD” is 1,5-cyclooctadiene. These alkene-platinum-silyl complexes may be prepared, e.g. by mixing 0.015 mole (COD)PtCI₂ with 0.045 mole COD and 0.0612 moles HMeSiCI₂.

One suitable platinum catalyst type is Karstedt’s catalyst, which is described in Karstedt’s U.S. Pat. Nos. 3,715,334 and 3,814,730. Karstedt’s catalyst is a platinum divinyl tetramethyl disiloxane complex typically containing about 1 wt.% of platinum in a solvent, such as toluene. Another suitable platinum catalyst type is a reaction product of chloroplatinic acid and an organosilicon compound containing terminal aliphatic unsaturation (described in U.S. Pat. No. 3,419,593).

The catalyst is present in the composition in a catalytic amount, i.e., an amount or quantity sufficient to promote a reaction or curing thereof at desired conditions. Varying levels of the catalyst can be used to tailor reaction rate and cure kinetics. The catalytic amount of the catalyst may be greater than 0.01 ppm, and may be greater than 1,000 ppm (e.g., up to 10,000 ppm or more) based on the total weight of the parts A and B compositions when combined. In certain embodiments, the catalytic amount of catalyst is less than 5,000 ppm, alternatively less than 2,000 ppm, and alternatively less than 1,000 ppm (but in any case, greater than 0 ppm). In specific embodiments, the catalytic amount of the catalyst may range from 0.01 to 1,000 ppm, alternatively 0.01 to 100 ppm, and alternatively 0.01 to 50 ppm, of metal based on the weight of the composition. The ranges may relate solely to the metal content within the catalyst or to the catalyst altogether (including its ligands). In certain embodiments, these ranges relate solely to the metal content within the catalyst. The catalyst may be added as a single species or as a mixture of two or more different species.

### Component (iv)

Component (iv) is a physical blowing agent. The physical blowing agent may be any suitable physical blowing agent. For example it may be a gas at room temperature such as nitrogen gas and/or carbon dioxide gas, a solid tailored to undergo a phase change at or below the temperature of application, such as solid carbon dioxide (dry ice) which boils at -78° C. and/or is a liquid tailored to undergo a phase change at the temperature of application. In the present disclosure the physical blowing agent is the main source for the gas that leads to the formation of the foam by replacing all the hydrogen gas typically used to blow silicone foam not least because of the danger in using hydrogen gas in the vicinity of the hot pipes at high temperatures. In many embodiments, the reaction between the components (i) and (ii) essentially does not lead to the production of gas that leads to or aids in the formation of the foam.

The physical blowing agent chosen may be a liquid physical blowing agent selected in accordance with its boiling point such that it undergoes a phase change from a liquid to a gaseous state during exposure to atmospheric pressure and the temperature of the cure process, e.g. a temperature greater or equal to (≥) 10° C., alternatively ≥ 20° C., alternatively ≥ 30° C., alternatively ≥ 40° C., alternatively ≥ 50° C., alternatively ≥ 60° C., alternatively ≥ 70° C., alternatively ≥ 80° C., alternatively ≥ 90° C., alternatively ≥ 100° C. In the case of room temperature vulcanization systems, such a liquid physical blowing agent chosen may have a boiling point of between 10 and 30° C., i.e. such that it undergoes a phase change from a liquid to a gaseous state during exposure to atmospheric pressure within this temperature range.

The amount of physical blowing agent utilized can vary depending on the desired outcome. For example, the amount of physical blowing agent can be varied to tailor final foam density and foam rise profile.

Useful physical blowing agents include hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), ethers, ketones and esters, for example methyl formate, ethyl formate, methyl acetate or ethyl acetate, in liquid form or air, nitrogen or carbon dioxide as gases. In certain embodiments, the physical blowing agent comprises a compound selected from the group consisting of propane, butane, isobutane, isobutene, isopentane, dimethylether or mixtures thereof. In many embodiments, the blowing agent comprises a compound that is inert.

In various embodiments, the physical blowing agent comprises a hydrofluorocarbon (HFC). “Hydrofluorocarbon” and “HFC” are interchangeable terms and refer to an organic compound containing hydrogen, carbon, and fluorine. The compound is substantially free of halogens other than fluorine.

Examples of suitable HFCs include aliphatic compounds such as 1,1,1,3,3-pentafluoropropane (HFC-245fa), 1,1,1,3,3-pentafluorobutane (HFC-365mfc), 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, and perfluorooctane; as well as aromatic compounds such as fluorobenzene, 1,2-difluorobenzene; 1,4-difluorobenzene, 1,3-difluorobenzene; 1,3,5-trifluorobenzene; 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene. In certain embodiments, HFC-365mfc and HFC-245fa may be preferred due to their increasing availability and ease of use, with HFC-365mfc having a higher boiling point than HFC-245fa which may be useful in certain applications. For example, HFCs having a boiling point higher than 30° C., such as HFC-365mfc, may be desirable because they do not require liquefaction during foam processing. In specific embodiments, component (iv) comprises 1,1,1,3,3-pentafluoropropane (HFC-245fa).

As previously discussed component (iv) is the only blowing agent used when preparing foams as described herein; i.e. for the avoidance of doubt, the composition described herein does not include a chemical blowing agent. Typically, there is provided from 2 to 20% by weight of the combined part A and part B composition. The amount of physical blowing agent added depends on the saturation limit of the polymer, as well as the desired density and foam rise profile.

As hereinbefore described the composition herein may include hollow glass microspheres. Any suitable hollow glass microspheres, alternatively referred to as glass microballoons or glass bubbles may be utilised herein. Glass microspheres are microscopic spheres of glass having a diameter of between 1 and 1000 µm, alternatively have having a diameter ranging from 10 to 300 µm. They can have average densities of about 0.1 grams/cm³ to approximately 0.7 grams/cm³, alternatively about 0.125 grams/cm³ to approximately 0.6 grams/cm³. Hollow glass microspheres used commercially can include both solid and hollow glass spheres as not all microspheres will expand sufficiently during the manufacturing process. If required for ease of mixing the hollow glass microspheres utilised herein may be provided with a silane coating to increase the matrix/microspheres interfacial strength and/or to render them hydrophobic and easier to mix with the remainder of the composition. Typically, when present they are provided in the composition in an amount of from 0.5 to 25 wt. % based on the combined weight of the part A and part B compositions.

### Other Optional Additive(s)

The composition may optionally further comprise additional ingredients or components (or “additives”), especially if the ingredient or component does not prevent the composition from curing and/or foaming. These are generally added to the composition when desired in an amount of from greater than (>) 0.1 wt.% and less than (<) 15 wt.% by weight of the composition, unless otherwise indicated. Examples of additional ingredients include, but are not limited to, surfactants; stabilizers; adhesion promoters; colorants, including dyes and pigments; antioxidants; carrier vehicles; heat stabilizers; flame retardants; thixotropic agents; flow control additives; inhibitors; fillers, including extending and reinforcing fillers.

One or more of the additives can be present as any suitable weight percent (wt.%) of the composition, such as about 0.1 wt.% to about 15 wt.%, about 0.5 wt.% to about 5 wt.%, or about 0.1 wt.% or less, about 1 wt.%, 2, 3, 4, 5, 6, 7, 8, 9, 10, 11, 12, 13, 14, or about 15 wt.% or more of the composition. One of skill in the art can readily determine a suitable amount of additive depending, for example, on the type of additive and the desired outcome. Certain optional additives are described in greater detail below.

Suitable surfactants (or “foaming aids”) include silicone polyethers, ethylene oxide polymers, propylene oxide polymers, copolymers of ethylene oxide and propylene oxide, other non-ionic surfactants, and combinations thereof. Further suitable surfactants may comprise a nonionic surfactant, a cationic surfactant, an anionic surfactant, an amphoteric surfactant, or a mixture of such surfactants.

In various embodiments, the composition comprises a fluorocarbon surfactant or fluorinated surfactant. The fluorinated surfactants can be any of those compounds known in the art which contain fluorine atoms on carbon and are also surfactants. These fluorinated surfactants can be organic or silicon containing. For example, fluorinated organic surfactants can be perfluorinated polyethers such as those which have repeating units of the formulae:

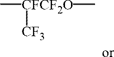

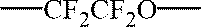

and mixtures of such units.

Silicon-containing fluorinated surfactants can be siloxanes, for example, which contain organic radicals having fluorine bonded thereto, such as siloxanes having repeating units of the formulae:

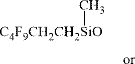

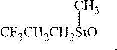

In various embodiments, adding the fluorinated surfactant to the composition decreases the cured foam density. In general, increasing the amount of fluorinated surfactant in the composition decreases the density of the foam. This is especially true for slow cure systems, where the surfactant stabilizes bubbles while the network forms and cures. The surfactant is utilised to regulate the cell size and density of the foamed elastomer. In one embodiment the foam suited for the insulation of the hot pipes as described herein has a foam density of >0 and <1 gm/cm³ and an average cell size of > 0 and < 5 mm. The active ingredient of the surfactant package is 407 type resin (i.e. a trimethylsiloxy-terminated dimethyl siloxane resin) with 2-perfluorohexyl ethyl alcohol. It can be added to either or both of the part A and part B compositions in an amount of from >0.1 wt.% and < 25 wt.% of the combined part A + part B composition.

In various embodiments, the composition further comprises an organopolysiloxane resin (“resin”). Suitable resins are as describe above. In certain embodiments, the resin is an MQ resin. The resin can be useful for stabilizing the foam.

Suitable pigments are understood in the art. In various embodiments, the composition further comprises carbon black, e.g. acetylene black, titanium dioxide, chromium oxide, zinc oxide, bismuth vanadium oxide, iron oxides and mixtures thereof.

The composition may include one or more fillers. The fillers may be one or more reinforcing fillers, non-reinforcing fillers, or mixtures thereof. Examples of finely divided, reinforcing fillers include high surface area fumed and precipitated silicas including rice hull ash and to a degree calcium carbonate. Examples of finely divided non-reinforcing fillers include crushed quartz, diatomaceous earths, barium sulphate, iron oxide, titanium dioxide and carbon black, talc, and wollastonite. Other fillers which might be used alone or in addition to the above include carbon nanotubes, e.g. multiwall carbon nanotubes aluminite, hollow glass spheres, calcium sulphate (anhydrite), gypsum, calcium sulphate, magnesium carbonate, clays such as kaolin, aluminum trihydroxide, magnesium hydroxide (brucite), graphite, copper carbonate, e.g. malachite, nickel carbonate, e.g. zarachite, barium carbonate, e.g. witherite and/or strontium carbonate e.g. strontianite. Further alternative fillers include aluminum oxide, silicates from the group consisting of olivine group; garnet group; aluminosilicates; ring silicates; chain silicates; and sheet silicates. In certain embodiments, the composition includes at least one filler comprising hollow particles, e.g. hollow spheres. Such fillers can be useful for contributing to porosity and/or overall void fraction of the foam.

The filler if present, may optionally be surface treated with a treating agent. Treating agents and treating methods are understood in the art. The surface treatment of the filler(s) is typically performed, for example with a fatty acid or a fatty acid ester such as a stearate, or with organosilanes, organosiloxanes, or organosilazanes such as hexaalkyl disilazane or short chain siloxane diols. Generally, the surface treatment renders the filler(s) hydrophobic and therefore easier to handle and obtain a homogeneous mixture with the other components in the composition. Silanes such as R⁵ₑSi(OR⁶)₄₋ₑ where R⁵ is a substituted or unsubstituted monovalent hydrocarbon group of 6 to 20 carbon atoms, for example, alkyl groups such as hexyl, octyl, dodecyl, tetradecyl, hexadecyl, and octadecyl, and aralkyl groups such as benzyl and phenylethyl, R⁶ is an alkyl group of 1 to 6 carbon atoms, and subscript “e” is equal to 1, 2 or 3, may also be utilized as the treating agent for fillers.

In various embodiments, the composition further comprises a reaction inhibitor to inhibit the cure of the composition. These inhibitors are utilised to prevent premature cure in storage and/or to obtain a longer working time or pot life of a hydrosilylation cured composition by retarding or suppressing the activity of the catalyst. Inhibitors of hydrosilylation catalysts, e.g. platinum metal-based catalysts are well known in the art and may include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

One class of known inhibitors of platinum catalysts includes the acetylenic compounds disclosed in US 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor concentrations as low as 1 mole of inhibitor per mole of the metal of catalyst (iii) will in some instances impart satisfactory storage stability and cure rate. In other instances, inhibitor concentrations of up to 500 moles of inhibitor per mole of the metal of catalyst (iii) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10% by weight of the composition. Mixtures of the above may also be used.

In various embodiments, the composition further comprises an adhesion-imparting agent. The adhesion-imparting agent can improve adhesion of the foam to a base material being contacted during curing. In certain embodiments, the adhesion-imparting agent is selected from organosilicon compounds having at least one alkoxy group bonded to a silicon atom in a molecule. This alkoxy group is exemplified by a methoxy group, an ethoxy group, a propoxy group, a butoxy group, and a methoxyethoxy group. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl)ethyl group, a 3-(3,4-epoxycyclohexyl)propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom.

This organosilicon compound generally has a silicon-bonded alkenyl group or silicon-bonded hydrogen atom. Moreover, due to the ability to impart good adhesion with respect to various types of base materials, this organosilicon compound generally has at least one epoxy group-containing monovalent organic group in a molecule. This type of organosilicon compound is exemplified by organosilane compounds, organosiloxane oligomers and alkyl silicates. Molecular structure of the organosiloxane oligomer or alkyl silicate is exemplified by a linear chain structure, partially branched linear chain structure, branched chain structure, ring-shaped structure, and net-shaped structure. A linear chain structure, branched chain structure, and net-shaped structure are typical. This type of organosilicon compound is exemplified by silane compounds such as 3-glycidoxypropyltrimethoxysilane, 2-(3,4-epoxycyclohexyl)-ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxyl group and at least one silicon-bonded alkenyl group in the molecule; and methyl polysilicate, ethyl polysilicate, and epoxy group-containing ethyl polysilicate.

The content of the adhesion-imparting agent in the composition is not particularly limited. In certain embodiments, the content of the adhesion-imparting agent is from about 0.01 to about 10 parts by mass per 100 parts total mass of components (A) and (B).

Such hydrosilylation cure compositions are usually stored in a minimum of two parts prior to use in order to avoid premature curing. For this disclosure the compositions are preferred to be stored in two parts, i.e. a two-part system for providing the composition (referred to herein as the “system”). The system comprises a first part, part A and a second part, part B. Part A comprises at least components (i) and (iii) and Part B comprises at least components (i) and (ii) with part A free of component (ii) and part B free of component (iii).

The part A composition does not include any of component (ii) and the part B composition does not include any of component (iii) in order to avoid premature curing and foam formation prior to step (d).

Hydrosilylation catalyst (iii) is present in a catalytically effective amount. Thus, the composition is generally classified as a hydrosilylation reaction composition, and the silicone material e.g. foam is cured via hydrosilylation reaction of at least components (i) and (ii). In the case of a silicone foam, the physical blowing agent (iv) may, for example, be a liquid physical blowing agent which undergoes a phase change from a liquid to a gaseous state during exposure to atmospheric pressure and a temperature ≥ 0° C. During cure, the blowing agent (iv) blows the reaction mixture of the composition to form the foam. Typically, the foam suited for the insulation of the hot pipes as described herein has a density of > 0 and <1 gm/cm³ and average cell size of > 0 and < 5 mm. When present, the glass microspheres (v) may be included in the part A composition or the part B composition or may be present in both the part A composition and the part B composition.

The silicone compositions described herein require a suitable mixer unit which may be adapted to mix and dispense the silicone composition around the hot pipe to be insulated or into the cavity in which the pipe is situated. It will be appreciated that given the nature of the ingredients involved the composition will have to be mixed on site in a mobile unit and the final composition, once the part A and part B compositions are mixed together, needs to be supplied to the point of delivery, i.e. down the hose whilst avoiding premature cure.

Hence, the mixing process will necessitate at least two optionally controllable metering pump/systems to ensure the appropriate part A and part B compositions are mixed together before the final composition reaches the point of delivery. The mixing unit may include holding tanks, each for storing one or more reactants, or the part A and part B compositions. These may be temperature controlled as may all aspects of the mixing process so as to be able to keep the ingredients/mixtures at suitable temperatures prior to final delivery. Controllable metering pumps may be provided to enable the operator to vary the amount of each ingredient being introduced into the different necessary steps at predetermined temperature and pressure.

Hence, any suitable mixing unit able to accommodate the above may be utilised to prepare the silicone composition. It will be appreciated that the unit will require certain particular requirements in situations where the silicone composition is being delivered as a foam on to the pipe or into the cavity surrounding the pipe. Accordingly, a self-contained, mobile system is necessitated as the part A and part B compositions need to be mixed immediately before application (to avoid premature cure) and there needs to be a suitable means for delivering silicone composition or foam to the hose which in turn has to be capable for the purpose of delivering a well-blended coating or foam through said hose.

The mixer unit may be situated at/fixed to the first end of the hose, such that the part A and part B compositions are transported down the hose separately and mixed immediately prior to application on the pipe. Alternatively, the mixer unit may be situated at/fixed to the second end of the hose, such that the part A and part B compositions are mixing whilst being transported through the hose. In a further alternative the part A and part compositions may be mixed remote from the hose and then the part A and part B compositions arrive at the second end of the hose ready mixed.

When the mixing unit is at the first end of the hose i.e. near the section of the pipe to be coated/insulated, the mixing unit may take any suitable form such as for the sake of example, a static mixer and a dispensing tip such that the dispensing tip may be used to apply the silicone composition on to the pipe and/or into the cavity surrounding the pipe. In this scenario the part A and part B mixture will only mixed for a very short time prior to application on to the pipe.

When the mixing unit is situated at the second end of the hose or is remote from the hose, the mixing unit may comprise any suitable means and may, for example comprise a mixing block, a static mixer and finally a dispensing tip or any combination of one or more of these. In this scenario however, it will be necessary to ensure that no substantial cure takes place during passage of the silicone composition through the hose and as such the composition may optionally require a cure inhibitor to be present to aid in the delay of the cure process during application to prevent premature curing in the hose.

In one embodiment herein the silicone composition is adapted to include a physical blowing agent and to be consequently used to form a produce a silicone foam. When the silicone composition is being prepared to be supplied as a silicone foam in which case it may be prepared via the following continuous process which comprises the steps of
(a) blending a part A composition comprising components (i) one or more silicone polymers containing at least two alkenyl or alkynyl groups per molecule and (iii) a hydrosilylation catalyst and separately blending a part B composition comprising a further amount of component (i) and (ii) an Si—H containing crosslinker, in each case as described above;
(b) introducing the part A composition and the Part B composition into respective mixing containers and mixing;
(c) transferring resulting part A and part B mixtures of step (b) into respective pumping means;
(d) pumping the resulting part A and part B mixtures of steps (b) and (c) into a mixer unit and mixing to form a foam; and
(e) dispensing the resulting foam; wherein
(f) Component (iv) a physical blowing agent is introduced into one or both of the part A composition or the part B composition during step (a) or step (b) and/or is introduced into the mixer unit during step (d).

A mixing unit is provided herein which is adapted to provide a suitable silicone composition to the point of delivery utilizing the process described above.

As described above Parts A and B of the composition are kept separate until steps c/d of the method as described herein to prevent premature cure of the composition, for ease of handling and storage, for ease of formulation, etc. Typically, when present, the reaction inhibitor is present in part B with component (iii) but otherwise, each of the other optional components of the composition can be in either or both part A and part B or if desired may be introduced in one or more additional parts separate from the two parts (such that the system may be a three or more part system). As hereinbefore described component (iv) is introduced into one or both of the part A composition or the part B composition during step (a) or step (b) and/or is introduced into the mixer unit during step (d).

In step (a) of the process herein the ingredients of the part A composition are blended together and separately the ingredients of the part B composition are also blended together to form respective blends. The part A blend composition might include, for the sake of example, one or more polymers in accordance with component (i) as hereinbefore described, component (iii) and one or more of the aforementioned optional components such as a surfactant, pigments or colorants and/or an MQ resin foam stabilizer. The part B blend composition might include, for the sake of example, one or more polymers in accordance with component (i) as hereinbefore described, component (ii) and one or more of the aforementioned optional components such as a surfactant, pigments or colorants and/or an MQ resin foam stabilizer. In step (a) if optional filler is present in the composition of part A or part B then typically a base comprising component (i) polymer and said filler will initially be prepared. Where required and if not pretreated the filler may be hydrophobically treated in-situ with a hydrophobing agent as described above during the preparation of the base. The remaining ingredients would then be introduced into said base after the preparation of the base. In the case when no filler is present in one or both of part A and part B the ingredients may be blended in any order of addition, optionally with a master batch, and optionally under shear.

In step (b) the part A blend composition and part B blend composition resulting from step (a) are each transferred into a respective mixing container. In one embodiment the mixing container for one or preferably both of the part A and part B blend compositions is a stirred tank or the like suitable for undertaking thorough mixing of the respective blend compositions. Optionally each mixing container is temperature and/or pressure controllable such that the part A composition and part B compositions being mixed can be maintained within desired temperature and/or pressure range(s).

In step (c) the thoroughly mixed compositions of part A and part B resulting from step (b) are transferred to a pump means. Optionally the pump means in each instance is a positive displacement and/or is a metering pump. Optionally each pump means is temperature controllable such that the part A composition and part B composition can each be maintained within a desired temperature range. Preferably, there is sufficient overpressure maintained in the pump means compared with the pressure in the respective mixing containers to ensure boiling of component (iv) the physical blowing agent, if present, in either or both of the part A and/or part B compositions is prevented.

In step (d) the compositions of part A and part B transferred to the pump means in step (c) are pumped into a further mixing unit which mixes the part A and part B compositions and generates the foam resulting therefrom. The mixing unit of step (d) may be a mixing block for at least the initial mixing of part A and part B compositions and then the resulting combined composition may be passed through a static mixer before being dispensed. Alternatively, the resulting foam may be dispensed directly from the mixing block. In step (d) the compositions of part A and part B are transferred into the mixer under predefined conditions such as flow rate, pressure and temperature to optimize the mixing process and foam generation.

In step (e) the foam generated is dispensed from the mixing unit identified in step (d) via any suitable means. In one embodiment the dispensing means is a suitable dispensing tip which may be utilised to control the cell size of the silicone elastomer foam generated herein.

Furthermore, as described above the mixer unit may be situated at/fixed to the first end of the hose, such that the part A and part B compositions are transported down the hose separately and mixed immediately prior to application on the pipe. Alternatively, the mixer unit may be situated at/fixed to the second end of the hose, such that the part A and part B compositions are mixing whilst being transported through the hose. In a further alternative the part A and part compositions may be mixed remote from the hose and then the part A and part B compositions arrive at the second end of the hose ready mixed.

Step (f) relates to the introduction of the physical blowing agent. The physical blowing agent may, for the sake of example,
(1) Be added completely into the part A blend during step (a); or alternatively
(2) Be added completely into the part A composition during step (b); or alternatively
(3) Be added completely into the part B blend during step (a); or alternatively
(4) Be added completely into the part B composition during step (b); or alternatively
(5) Be added partially into the part A blend and partially into the part B blend during step (a); or alternatively
(6) Be added partially into the part A composition and partially into the part B composition during step (b); or alternatively
(7) Be added partially into the part A composition and partially into the part B composition during step (b); or alternatively
(8) Be added completely directly into the mixing unit of step (d);
(9) Be added partially into the part A blend during step (a) and partially directly into the mixing unit of step (d); or alternatively
(10) Be added partially into the part A composition during step (b) and partially directly into the mixing unit of step (d); or alternatively
(11) Be added partially into the part B blend during step (a) and partially directly into the mixing unit of step (d); or alternatively
(12) Be added partially into the part B composition during step (b) and partially directly into the mixing unit of step (d); or alternatively
(13) Be added partially into the part A blend, partially into the part B blend during step (a) and partially directly into the mixing unit of step (d); or alternatively
(14) Be added partially into the part A composition, partially into the part B composition during step (b) and partially directly into the mixing unit of step (d); or alternatively
(15) Be added partially into the part A composition and partially into the part B composition during step (b), and partially directly into the mixing unit of step (d).

The glass microspheres, when present in the composition, may be added simultaneously with the physical blowing agent or separately to the physical blowing agent by way of any of the above alternatives, although glass microspheres are preferably introduced before the mixing unit of step (d) in any of the above routes.

When the physical blowing agent is introduced into the part A blend and/or part B blend during step (a) any suitable means of introduction may be utilised. When the physical blowing agent is introduced into the part A composition and/or part B composition during step (b) any suitable means of introduction may be utilised. When the physical blowing agent is introduced directly into the mixing unit during step (d) any suitable means of introduction may be utilised although preferably the blowing agent is introduced via a suitable pumping means.

When a foam is being generated to insulate a pipe, the foam is generally a closed-cell foam having a density < 0.8 grams per cubic centimeter (g/cm³), alternatively < 0.7 g/cm³, alternatively < 0.6 g/cm³, alternatively < 0.5 g/cm³, alternatively < 0.45 g/cm³, alternatively < 0.4 g/cm³, alternatively < 0.35 g/cm³, alternatively < 0.3 g/cm³, alternatively < 0.25 g/cm³, alternatively < 0.2 g/cm³, alternatively < 0.15 g/cm³, alternatively < 0.1 g/cm³, and alternatively < 0.05 g/cm³.

If density is too low, the foam may lack desired structural integrity for certain applications. Density of the foam can be determined via methods understood in the art. For example, density of the foam can be measured via the Archimedes principle, using a balance and density kit, and following standard instructions associated with such balances and kits. An example of a suitable balance is a Mettler-Toledo XS205DU balance with density kit.

The foam produced utilizing the continuous process described herein, may have pores that are generally uniform in size and/or shape. For example, the foam may have an average pore size less than or equal to (≤) 5 millimeters, alternatively ≤ 2.5 millimeters, alternatively ≤ 1 millimeter, alternatively ≤ 0.5 millimeters, alternatively ≤ 0.25 millimeters, alternatively ≤ 0.1 millimeters, and alternatively ≤ 0.05 millimeters.

Average pore size can be determined via methods understood in the art. For example, ATSM method D3576-15 with the following modifications may be used: (1) image a foam using optical or electron microscopy rather than projecting the image on a screen; and (2) scribe a line of known length that spans greater than 15 cells rather than scribing a 30 mm line.

Pressure control valves may be incorporated in line between the pump and the mixing unit during step (d) to control the pressure therebetween.

One or more of the different steps in the continuous process may be temperature, flow and/or pressure controlled enabling the blend/composition involved to be maintained during different stages of the process within a predefined temperature range, e.g. a blend or composition might be heated or cooled prior to introduction of the physical blowing agent in order to accelerate or decelerate the cure and the phase change of the physical blowing agent selected, depending on the boiling point of the agent being used and the desired end properties of the foam being produced.

Advantageously, it was determined that various properties of foam produced using the process of this embodiment may be controlled by controlling different aspects of the process. This can be very important for a continuous process as described herein as the physical properties of the foam produced can effect a variety of the properties sought after by end users of the foams produced by the continuous process herein such as, for the sake of example, thermal conductivity, acoustic impedance, and foam density.

As mentioned previously, when the dispensing means herein may include a suitable dispensing tip. When present, if desired, the dispensing tip may be utilised to control the cell size of the silicone elastomer foam generated herein by varying the dispensing tip gauge. Once the cavity surrounding a target pipe has been opened the hose may be inserted along the length of the cavity in any suitable manner e.g. using the aforementioned carriage. The hose may then be positioned next to the pipe and a second end of the hose is attached to the continuous processing unit described above for providing a silicone foam using a physical blowing agent (but no chemical blowing agents) and depicted in FIG. 1. The silicone composition is then pumped through the system and hose and directed around the targeted hot pipe or in the cavity region around same. As the cavity fills or the pipe is thoroughly coated, the hose is gradually withdrawn and the coating and/or insulation in the cavity is left to cure.

In any embodiment herein irrespective of whether the composition is produced as a foam or as a coating, when first formed, each blend/composition of part A, part B and the resulting combination thereof can have a wide viscosity range dependent on the ingredients used. In various embodiments, the composition has a viscosity of from about 1,000 to about 100,000 mPa.s, alternatively about 1,000 to about 50,000 mPa.s, alternatively about 1,000 to about 25,000 mPa.s, alternatively about 1,000 to about 10,000 mPa.s, alternatively about 1,000 to about 7,500 mPa.s, and alternatively about 2,500 to about 5,000 mPa.s. Viscosity can be determined via methods understood in the art such as with a Brookfield LV DV-E viscometer.

The hose, the mixing units and the dispensing means may each have a variety of monitors adapted to monitor the remote process and to send signals to a control unit. The monitors might include one or more temperature monitors, one or more pressure monitors and or one or more flow monitors. The monitors may for example be designed to send a signal to a control unit if a parameter strays outside a predefined range and/or said monitors may transmit signals to the control unit so that it can determine the speed of withdrawal of the hose from the cavity. The monitors may also be able to allow the control means to vary the supply of e.g. part A composition or part B composition in case of mixing issues and/or blockages e.g. in the hose.

In one embodiment the pipe may be encapsulated using a composition as herein described without blowing agent to provide an encapsulating coating on the pipe e.g. if the pipe were leaking and then to provide a foam insulating layer on top of the initial coating as the main insulation layer.

Typically the mixing unit will have to be able to control the delivery of the different ingredients and mixing capabilities by monitoring flow rates and temperatures of the reactants, the pressure in the system and flow rate of the composition throughout the mixing unit and the hose.

### BRIEF DESCRIPTION OF THE FIGURES

The Figures herein are provided to illustrate the methods utilised herein and not to limit the disclosure and are as follows:

FIG. 1 is a schematic view of an embodiment of this disclosure providing a continuous process adapted to produce the silicone foams utilising a physical liquid blowing agent suitable to encapsulate and/or insulate hot pipes and/or to fill cavities surrounding hot pipes;

FIG. 2 is a depiction of the test pipe/cavity unit used for Example 6 described below; and

FIGS. 3a and 3b are photos of the foam generated during Ex. 6 at 150° C. and at 250° C.

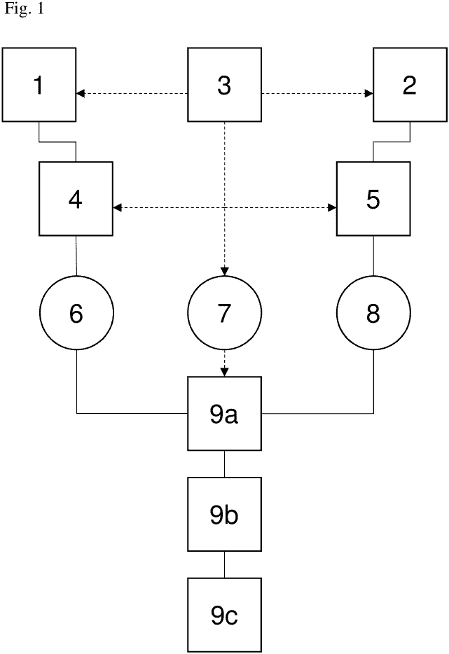

In FIG. 1 there is provided a schematic view of a continuous process for making a silicone foam as described herein for insulating hot pipes. There is provided a receiving means (1) for receiving the ingredients of a part A composition as defined herein and a receiving means (2) for receiving the ingredients of a part B composition as defined herein. There is also provided a stirred tank (4) provided to mix the ingredients of the part A composition and a stirred tank (5) provided to mix the ingredients of the part B composition. There is also provided a pumping means (6) adapted to pump mixed part A composition into a mixing unit ((9a), (9b) and/or (9c)) as well as a pumping means (8) adapted to pump mixed part B composition into said mixing unit ((9a), (9b) and/or (9c)). Mixing unit ((9a), (9b) and/or (9c)) comprises one of mixing block (9a), static mixer (9b) and/or dispensing tip (9c) and is provided to mix the part A composition and part B composition together and to dispense the resulting silicone foam.

In this disclosure the mixing unit ((9a), (9b) and/or (9c)) may be situated prior to entrance into the hose (not shown) or subsequent to the hose. In the latter case said hose is divided into at least two channels such that the part A composition is transported through the hose to the mixing unit ((9a), (9b) and/or (9c)) and then after mixing with the part B composition to the point of discharge and is finally discharged onto the hot pipe or into the cavity. Similarly, the part B composition is transported through the hose to the mixing unit ((9a), (9b) and/or (9c)) in a separate channel and then after mixing with the part B composition to the point of discharge and is finally discharged onto the hot pipe or into the cavity. In a further alternative, the mixing unit may be partially prior to entrance into the hose and partially after the hose. For example, this might occur when one or both of (9a) and (9b) is/are situated prior to the entrance of the hose between the mixing unit and the hose, and (9c) is situated at the exit of the hose or alternatively when (9a) is prior to the hose and (9b) and/or (9c) are situated after transport through the hose. In each instance the mixing regime will have to be designed to prevent premature mixing during passage through the hose prior to delivery around the pipe or into the cavity into which the pipe is situated.

As hereinbefore described the foam is generated using a physical liquid blowing agent. A reservoir of said physical liquid blowing agent is contained in container (3). The physical liquid blowing agent may be supplied during the continuous process to any one or more of receiving means (1), receiving means (2), stirred tank (4), stirred tank (5) and/or directly into mixing block (9a) so that it is thoroughly mixed with the other ingredients in order to continuously produce a silicone foam. When supplied directly into mixing block (9a) the physical liquid blowing agent may if desired be transported thereto by way of a pump (7) to aid addition into the mixing block (9c). One or more of receiving means (1), receiving means (2), stirred tank (4), stirred tank (5) and/or mixing unit ((9a) and optionally (9b) and/or (9c)) may be temperature and pressure controlled. Given the nature of the physical liquid blowing agent it may be desired to vary the temperature in regions pre or post addition of the physical liquid blowing agent as a means of controlling when and where the blowing agent changes state from a liquid to a solid. Such temperature control must be able to both heat and cool the respective blend and/or composition so that it can be adapted for use with a variety of physical liquid blowing agents dependent on their boiling points. The foam commences generation immediately after mixing of the part A and part B compositions and continues to be generated during its passage through the mixing unit ((9a), (9b) and/or (9c)) and may even continue to be formed after dispatch therefrom.

As previously mentioned the glass microspheres, when present, may be added simultaneously with the physical blowing agent or separately to the physical blowing agent but in any of the above routes.

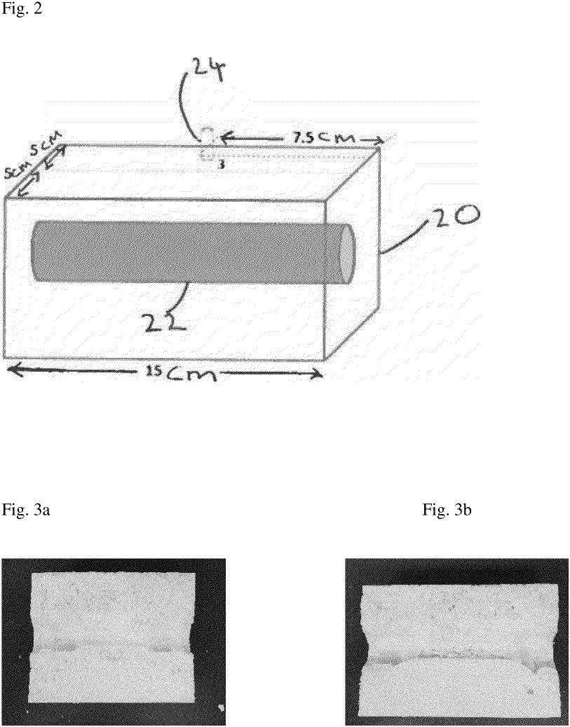

FIG. 2 and FIGS. 3a and 3b are discussed in more detail in conjunction with Ex. 6 below.

### INDUSTRIAL APPLICABILITY

The silicone compositions, silicone materials including foams, and methods of this disclosure are useful to at least partially cover or encapsulate /pipes utilised to transport hot fluids at temperature which can be > 150° C. e.g. up to or >250° C. and or to fill the cavities surrounding said pipes for thermal insulation purposes. Moreover, silicone compositions, silicone materials including foams, and methods of this disclosure can be used as a fire block. In general, the silicone compositions, silicone materials including foams, and methods of this disclosure can be prepared at room temperature or thereabouts.

The following examples, illustrating the compositions, foams, and methods, are intended to illustrate and not to limit the invention.

### EXAMPLES

Compositions were generated utilizing different types and amounts of components. These are detailed below. All amounts are in weight % unless indicated otherwise. As discussed above all viscosities are measured at 25° C. using a Brookfield LV DV-E viscometer. The alkenyl and/or alkynyl content of polymers as well as the silicon-bonded hydrogen (Si—H) content of polymers was determined using quantitative infra-red analysis in accordance with ASTM E168.

A series of samples were prepared to show the suitability of silicone foams using only physical blowing agents. There was one Reference Example (Ref. 1) and five examples supporting the present disclosure (Ex. 1 to Ex. 5). The compositions were based on additions of further ingredients to the following part A and part B compositions, excepting that Ref. 1 had no surfactant present and some examples were initially prepared without surfactant but having surfactant added later in the process to the part A composition. The same part B composition was used with all samples. When mixed together the part A composition and the part B composition were mixed in a 1 : 1 weight ratio.

In the following Tables:
Polymer 1 is Dimethylvinylsiloxy-terminated dimethyl siloxane, having a viscosity of ~430 mPa.s and ~0.46 wt.% Vi;
Polymer 2 is Dimethylvinylsiloxy-terminated dimethyl siloxane, having a viscosity of ~39,000 mPa.s and ~0.08 wt.% Vi;
Surfactant is Trimethylsiloxy-terminated dimethyl siloxane 407 type resin with 2-(perfluorohexyl) ethyl alcohol, having a viscosity of ~350 mPa.s;
Catalyst is 1,3-Diethenyl-1,1,3,3 -Tetramethyldisiloxane Complexes (Platinum)) in (Dimethyl Siloxane, Dimethylvinylsiloxy-terminated; Dimethyl Siloxane;
Polymer 1/resin blend is a blend of Dimethylvinylsiloxy-terminated dimethyl siloxane, having a viscosity of ~430 mPa.s and ~0.46 wt.% Vi; and a ^{Vi}MMQ resin, having a viscosity of ~45,000 mPa.s and ~0.39 wt.% Vi; and
cross-linker is trimethylsiloxy-terminated, methylhydrogen siloxane, trimethylsiloxy-terminated, having a viscosity of ~30 mPa.s and ~1.6 wt.% SiH.

The liquid physical blowing agent used in the examples was 1,1,1,3,3-pentafluoropropane (HFC-245fa) which has a boiling point of about 15.3° C. The solid physical blowing agent used in the examples was frozen carbon dioxide (dry ice) which boils at -78° C. The gaseous physical blowing agent used in the examples was nitrogen gas.

A reference material Ref. 1 was utilised to enable the difference between a blown foam and a non-blown silicone material. Ref. 1 material comprised 7.53 g of polymer 1, 2.45 g of polymer 2 and 0.03 g of catalyst in part A and 6.27 g of polymer 1, 3.41 g of Polymer 1/resin blend and 0.32 g of cross-linker in part B.

Five examples were also prepared. The amounts (g) used in the compositions tested are provided in Tables 1a and 1c and the wt. % of the ingredients in said compositions are provided in tables 1b and 1d.

TABLE 1a

Part A composition in (g)

| | Ex. 1 | Ex. 2 | Ex. 3 | Ex. 4 | Ex. 5 |
|---|---|---|---|---|---|
| Polymer 1 | 7.53 | 7.53 | 7.53 | 7.53 | 7.53 |
| Polymer 2 | 2.45 | 2.45 | 2.45 | 2.45 | 2.45 |
| Surfactant | 1.2 | 1.2 | 0.6 | 0.6 | 0.6 |
| Catalyst | 0.03 | 0.03 | 0.03 | 0.03 | 0.03 |
| HFC 245fa | 1.6 | | | | 1.6 |
| Nitrogen Purge | | Yes | | | |
| Dry ice | | | 2.0 | 4.0 | 2.0 |
| Total wt. part A (g) | 12.8 | 11.2 | 12.6 | 14.60 | 14.20 |

TABLE 1b

Part A composition in wt. % of total composition when mixed

| | Ex. 1 | Ex. 2 | Ex. 3 | Ex. 4 | Ex. 5 |
|---|---|---|---|---|---|
| Polymer 1 | 33.01 | 35.50 | 29.87 | 25.78 | 28.08 |
| Polymer 2 | 10.73 | 11.54 | 9.71 | 8.38 | 9.13 |
| Catalyst | 0.12 | 0.13 | 0.11 | 0.09 | 0.01 |
| Surfactant | 5.26 | 5.66 | 2.38 | 2.05 | 2.24 |
| HFC 245fa | 7.02 | | | | 5.97 |
| Nitrogen Purge | | Yes | | | |
| Dry ice | | | 7.94 | 13.7 | 7.46 |
| Total wt.% of combined pts A and B | 56.14 | 52.83 | 50 | 50 | |

TABLE 1c

Part B composition in (g)

| | Ex. 1 | Ex. 2 | Ex. 3 | Ex. 4 | Ex. 5 |
|---|---|---|---|---|---|
| Polymer 1 | 6.27 | 6.27 | 6.27 | 6.27 | 6.27 |
| Polymer 1/resin blend | 3.41 | 3.41 | 3.41 | 3.41 | 3.41 |
| Cross-linker | 0.32 | 0.32 | 0.32 | 0.32 | 0.32 |
| Surfactant | | | 0.6 | 0.6 | 0.6 |
| Dry ice | | | 2 | 4 | 2 |
| Total wt. part B in g | 10 | 10 | 12.6 | 14.6 | 12.6 |
| Total wt. part A + part B in g | 22.8 | 21.2 | 25.2 | 29.2 | 26.8 |

TABLE 1d

Part B composition in wt. % of total composition when mixed

| | Ex. 1 | Ex. 2 | Ex. 3 | Ex. 4 | Ex. 5 |
|---|---|---|---|---|---|
| Polymer 1 | 27.5 | 29.57 | 24.88 | 21.47 | 23.39 |
| Polymer 1/resin blend | 14.96 | 16.09 | 13.54 | 11.68 | 12.73 |
| Cross-linker | 1.4 | 1.51 | 1.27 | 1.10 | 1.19 |
| Surfactant | | | 2.38 | 2.05 | 2.24 |
| Dry ice | | | 7.94 | 13.7 | 7.46 |
| Total wt. part B in g | | | | | |
| Total % wt. part A + part B | 100 | 100 | 100 | 100 | 100 |

Notes regarding the Ex. 1 to 5:

Ex. 1: A liquid physical blowing agent, 1,1,1,3,3-pentafluoropropane (HFC-245fa) was added to the part A composition.

Ex. 2: A gaseous physical blowing agent was utilised in Ex. 2, The part A and part B compositions were separately were purged for 12 hours with gaseous nitrogen. The increase in weight by this process was not determined;

Ex. 3 The part A composition was prepared in a suitable container using the “without surfactant” composition depicted in Table 1a above and part B composition was prepared in a suitable container using the composition depicted in Table 1b above. Dry ice (frozen carbon dioxide) was then added to the part A composition and the part B composition and the respective containers were closed with a lid, but each lid had a pinhole therein to avoid too great a pressure build up. After the carbon dioxide had stopped boiling, surfactant was added to both Part A and Part B equally prior to the final mixing and foaming etc.

Ex. 4: This example was analogous to Ex. 3 with the exception that double the amount of dry ice was utilised as the solid physical blowing agent.

Ex. 5: In this example both a liquid physical blowing agent (HFC 245fa) and a solid physical blowing agent (dry ice) were utilised to blow the foam. The foam was allowed to rise and cure in the plastic container itself.

When the physical blowing agent is a solid, (e.g. solid carbon dioxide otherwise known as dry ice (boiling pt. -78° C.) or is a gas, e.g. nitrogen, the physical blowing agent is introduced into both the part A and part B compositions prior to their mixing together. When a liquid physical blowing agent is used it is designed to boil at around the temperature of cure of the composition herein e.g. 1,1,1,3,3-pentafluoropropane (HFC-245fa) the blowing agent was added into the part A composition such as Physical blowing agent(s) is added to Part A of the formulation shown above.

The ingredients of the part A and part B compositions, (excluding surfactant and blowing agent) are first prepared and mixed separately in Speedmixer at 3000 rpm for 20 s. The ingredients of the part A composition, (excluding surfactant and blowing agent) are first mixed using a Speedmixer at 3000 rpm for 20 s. Likewise, the ingredients of the part B composition, (excluding surfactant and blowing agent) are first mixed using a Speedmixer at 3000 rpm for 20 s. The desired amount of surfactant and blowing agent are then added into the part A composition or in these examples partly in the part A composition and partly in the part B composition. Subsequently the part B composition was then added to part A composition and the two parts are mixed thoroughly together, e.g. in a laboratory environment with a spatula for 30 s.

The resulting compositions were cured after mixing. Foaming was left to take place in the containers in which the part A and part B compositions were mixed. The following table provides a number of physical properties identified after analysis.

The “cure time’ results were a measure of the snap time which is determined by applying tongue depressor upon the substrate/foam. The composition /foam was deemed cured when no material is observed to be adhered to the tongue depressor.

The foams were then allowed to sit for 24 hours before further characterization. The density and cell size of the foams were measured. Density of the foam can be determined via methods understood in the art. For example, density of the foam can be measured via the Archimedes principle, using a balance and density kit, and following standard instructions associated with such balances and kits. An example of a suitable balance is a Mettler-Toledo XS205DU balance with density kit.

The average pore size (otherwise referred to as cell size) can be determined using a suitable method, as described in ATSM D3576 standard. The following modifications may be used: (1) image a foam using optical or electron microscopy rather than projecting the image on a screen; and (2) scribe a line of known length that spans greater than 15 cells rather than scribing a 30 mm line. The porosity of the foams was determined by calculation based on the result of the density value measured. The porosity of Ex. 1 is determined below as an example:
In Ex. 1 the density was measured as 0.44;
The porosity of a cured elastomer is zero;
The porosity of Ex. 1 is calculated as a % using the following equation:-
$$\left(1.0 - 0.44\right) \times 100 = 56 \%$$

TABLE 2

Reference (Ref. 1) and inventive examples (Ex. 1-5) with cure time, density, foam morphology, and average cell size
Formulations

| Properties | Ref. 1 | Ex. 1 | Ex. 2 | Ex. 3 | Ex. 4 | Ex. 5 |
|---|---|---|---|---|---|---|
| Cure time (min) | 3 | 4 | 4 | 3.5 | 4 | 4.5 |
| Density (g/cc) | 1 | 0.44 | 0.78 | 0.53 | 0.44 | 0.33 |
| Porosity (%) | 0 | 56 | 22 | 47 | 56 | 67 |
| Foam morphology (open or closed) | NA, no foam | closed | closed | closed | closed | closed |
| Average cell size (mm) | NA, no foam | 0.4 | 0.3 | 0.5 | 0.55 | 0.50 |
| Compressive strength (kPa) at 10% strain (ASTM D1621-16) | NA | 18.5 | 25.5 | | | 14.6 |

It will be seen that in each of Ex. 1 to 5 the foam morphology was closed cell. A closed cell morphology would suggest the likelihood of water penetrating through the foam is low.

Of the different examples above it was decided to prepare a larger scale example using the compositions utilised for Ex. 1 above in a suitable continuous process for insulating a cavity around a hot pipe using a continuous dispensing process of the type depicted in FIG. 1 to fill a test unit depicted in FIG. 2 herein.

In this example, hereafter referred to as Ex. 6, a continuous process as depicted in FIG. 1 was utilised with equal total amounts of part A and part B compositions being produced and mixed in together in the mixing unit. The liquid blowing agent HFC-245fa was introduced into stirred mixers (4) and (5) and the pumping means (6) and (8) were positive displacement ISCO pumps. The mixing unit utilised to mix the part A and part B compositions together in the current example contained each of (9a), (9b) and (9c). The following regime was utilised:
1. Blend the components of Parts A and B respectively in receivers (1) and (2)
2. Transfer 1000 grams of each of Parts A and B receivers (1) and (2)into respective stirred tanks (4) and (5)
3. Load 100 grams HFC-245fa blowing agent into each of stirred tanks (4) and (5)
4. Fill pistons of the positive displacement ISCO pumps (4) and (5), maintaining sufficient overpressure to prevent boiling the blowing agent.
5. Discharge the pumps (6) and (8) at a controlled rate, through mixing block (9a), static mixer (9b) and dispense tip (9c) into a collection container.

In this instance the final mixed composition was introduced into a sample pipe and cavity as depicted in FIG. 2 herein. The sample test piece depicted in FIG. 2 was a rectangular box (20) having the dimensions 10 cm x 10 cm x 15 cm as depicted. The inner pipe (22) had an outer diameter of 1.25 cm and was also 15 cm long. The final mixture of the part A and part B combined mix was introduced into the interior cavity of box (20) through the central “hose” (24) at the top of the box (20). Several of the dimensions are shown in FIG. 2. In example 6 samples were tested with pipe (22) temperature was maintained at 150° C. or 250° C. In each instance, the cavity temperature inside box (20) was approximately 75° C. The Ex. 6 compositions utilised for the testing were introduced into box (20) at approximately 20° C. i.e. slightly above the boiling pt. of the physical blowing agent being used (HFC-245fa). The composition of Ex. 6 was dispensed into box (20) through hose (24) at a rate of 200 ml per minute. Physical property results of the foams prepared using the continuous process and introduced into the cavity in the box at pipe temperatures of 150° C. and 250° C. are provided in Table 3.

TABLE 3

Ex. 6 dispensed on heated pipe maintained at 150° C. and 250° C.

| | | |
|---|---|---|
| Properties | Ex. 6- 150° C. | Ex. 6- 250° C. |
| Density (g/cc) | 0.35 | 0.44 |
| Porosity (%) | 65 | 56 |
| Foam morphology (open or closed) | closed | closed |
| Average cell size (mm) | 0.25 (away from the heated pipe) | 0.27 (away from the heated pipe) |

FIG. 3a depicts the foam produced in the box at pipe temperatures of 150° C. and FIG. 3b depicts the foam produced in the box at pipe temperatures of 250° C.

As previously indicated the pipe may be coated with a coating of silicone material which is not a foam. Two examples using alternative coating compositions for the encapsulation and/or insulation of the hot pipes or indeed the filling of the pipe cavity with such compositions are provided below as Examples 7 and 8. Again the compositions are two-part compositions which need to be suitably mixed prior to introduction of the composition into the pipe cavity or as a coating on the pipe itself. The part A compositions for said Ex. 7 and Ex. 8 are provided in Table 4a below and the part B compositions are depicted in Table 4b below.

TABLE 4a

Part A hot Pipe coating compositions

| | Ex. 7 | Ex. 8 |
|---|---|---|
| Dimethylvinylsiloxy-terminated Dimethyl Siloxane having a viscosity of about 500 mPa.s | 48 | 61 |
| Silica having an average particle size of 5 µm | 44.8 | 12.7 |
| CAB-O-SIL® MS-75D fumed silica | | 19.7 |
| 1,3-Diethenyl-1,1,3,3 -Tetramethyldisiloxane Complexes (Platinum)) in (Dimethyl Siloxane, Dimethylvinylsiloxy-terminated; Dimethyl Siloxane; | | 0.3 |
| Cerium hydrate | | 0.5 |
| Dimethylhydroxy terminated polydimethylsiloxane having a viscosity of about 15 mPa.s | | 4.7 |
| water | | 1.1 |
| pigment | 7 | |
| Pt catalyst | 0.2 | |

CAB-O-SIL® MS-75D fumed silica is a product sold by the Cabot Corporation.

TABLE 4b

Part B hot Pipe coating compositions

| | Ex. 7 | Ex. 8 |
|---|---|---|
| Dimethylvinylsiloxy-terminated Dimethyl Siloxane having a viscosity of about 2000 mPa.s | | 57.3 |
| Dimethylvinylsiloxy-terminated Dimethyl Siloxane having a viscosity of about 500 mPa.s | 48.3 | |
| Silica having an average particle size of 5 µm | 45.6 | 14 |
| CAB-O-SIL® MS-75D fumed silica | | 19.1 |
| Trimethylsiloxy-terminated Dimethyl, Methylhydrogen Siloxane, | 5.9 | 2.5 |
| Dimethylhydroxy terminated polydimethylsiloxane having a viscosity of about 15 mPa.s | | 4.5 |
| cyclic methylvinylsiloxanes | 0.2 | 0.1 |
| water | | 1.2 |
| Inhibitor masterbatch of 3.5% by weight of ethynyl-1-cyclohexanol (ETCH) in in a silicone rubber base composition. | | 1.3 |

The examples shown in the table above depict two very different liquid silicone rubber materials capable of filling a cavity underground and coating a steam pipe installation. The use of silicones has the added benefit of being a heat stable material capable of resisting the high temperatures experienced on the surface of the steam pipes to be coated.

Ex. 7 describes a material with a relatively low viscosity and therefore capable of a fast flow in narrow annular areas around a steam pipe in the order of 2 inches (5.08 cm) and a flow rate of 3 cm /s based on a box used for testing having the dimensions approximately 180 cm long by 12.5 cm wide and 12.5 cm high. and a time to cover the base of the box being 60 s.

Ex. 8 on the other hand displays a more thixotropic effect due to the much higher viscosity of the polymers used. Such a composition can be of use in areas where the annular space around the pipe can be in the order of 6 - 12 inches (15.24 - 30.48 cm) with a flow rate of 0.3 cm/s allowing the material to remain where applied rather than flowing away.

The compositions described as Ex. 7 and Ex. 8 in Tables 4a and 4b were used in turn to evaluate their potential and usability for the process of filling a large cavity housing to experimentally simulate the process of applying the materials in a large volume to coat and fill any cavity around steam pipes.

As previously indicated the test pieces used to provide a test cavity were boxes having the dimensions approximately 180 cm long by 12.5 cm wide and 12.5 cm high. Ex. 7 and 8 were tested in turn. The part A and part B compositions were brought together in the required ratio (1:1) using a high-pressure meter, mix, dispense, equipment (HFR) from Graco fitted with a static mixer attached to one end of the box.

The part A and B of each material was maintained at room temperature throughout the injection as the mixed material was pumped into the box filling the cavity over time. Once filled, the combined composition left to cure in the box.

Given the much higher viscosity and greater thixotropic nature of the composition used in Ex. 8 the flow behavior of the material is one where layers of subsequent material injected build on the previous and could tend to block the annular space around the pipe. Should a blockage occur in the field this would require a new excavation site to be created leading to significantly extended coating times which are unsatisfactory due to the often, public location of the steam lines and the significant disruption caused.

Therefore, the use of a retractable hose offers an advantage in both these systems as well as for other silicone materials considered whereby the hose can be withdrawn at a rate where flow and / or thixotropy of the material (hence any layering effect) can be adequately controlled. Ultimately leading to a more efficient filling of the annular space and a reduced application time.

A follow up experiment was undertaken using the same formulation as was used in Ex. 8 (see Tables 4a and 4b). This is referred to in Table 5 below as Ex. 9.

In Ex. 9 an alternative process was evaluated, i.e. the filling of a large cavity housing to experimentally simulate the process of applying the materials in a large volume to coat and fill any cavity around steam pipes underground. The same test pieces were used as in Ex. 7 and 8 above. The part A and B parts of the composition were mixed together in a 1 : 1 ratio using a high-pressure meter, mix, dispense, equipment (HFR) from Graco fitted with a static mixer attached to one end of the box. The parts A and B compositions were maintained at room temperature throughout the Ex. 9 process.

The part A and B were brought together in a static mixer (½″ (1.27 cm) 30 elements) where a 12 feet (3.66 m) long hose (⅜″ (0.95 cm) Polyester based “Parker parflex S10C/6”, rated to 2250 psi (155.13 MPa) was attached to the end of the static mixer. Prior to filling the box enough material was allowed through the static mixer to completely fill the hose. The hose was then fully extended to the end of the box and slowly retracted as the material was injected at a rate of 30 g/s and the box filled. After a period of approximately 20 mins the box was completely filled. The material was then allowed to cure in the box.

TABLE 5

| | Ex. 7 | Ex. 8 | Ex. 9 |
|---|---|---|---|
| Viscosity mPa.s (0.1 s⁻¹) | 5100 | 713000 | 713000 |
| Viscosity mPa.s (10 s⁻¹) | 2700 | 55000 | 55000 |
| Specific gravity | 1.38 | 1.21 | 1.21 |
| Time to cover base of box (s) @ 48 g/s | 140 | 660 | |
| Time to cover base of box (s) @ 150 g/s | 60 | -* | |
| Time to fill box (s) @ 30 g/s | - | - | 1200 |
| Time to fill box (s) @ 48 g/s | 680 | 780 | - |
| Time to fill box (s) @ 150 g/s | 218 | -* | - |

*= Pressure too high for injection

It was found that using this retractable hose method enabled the material to be less flow dependent which can be a challenge underground due to obstructions and annular space available around the pipe and therefore allow the material to be applied where specifically required.

What is claimed is:

1. A method for in-situ insulation and/or encapsulation of a restricted access pipe by gaining access to a pipe cavity in which a pipe to be insulated is situated, inserting a hose into the cavity so that a first end of the hose is remotely positioned next to the pipe and a second end of the hose is attached to a pumping system wherein a silicone composition is pumped through the hose and into the cavity surrounding from the remote first end of the tubing at a first predefined rate, the hose is gradually withdrawn from the cavity at a second predefined rate and the silicone material is allowed to cure and become rigid, thereby encapsulating and/or insulating the pipe.

2. The method in accordance with claim 1, wherein the first end of the hose is fixed to a carriage for transport along the extent of the pipe to be coated/insulated, enabling the hose to coat the pipe and/or fill the cavity for the whole extent of the pipe to be treated and to be gradually withdrawn from the cavity as the cavity is filled or the pipe coated.

3. The method in accordance with claim 2, wherein the carriage comprises a robotic means and/or a camera to enable an operator to control the robotic means and ensure the pipe is being correctly/fully coated and/or the cavity is being correctly/fully filled.

4. The method in accordance with claim 1, wherein the hose has a length such that the speed of flow of the silicone composition through the hoseis controlled to reach the point of delivery in a mixed form so as to be curable upon application onto the pipe or into the cavity and to avoid blockages within the hose due to premature cure of the silicone composition.

5. The method in accordance with claim 1, wherein the silicone composition is a hydrosilylation curable composition, the silicone composition comprising:
(i) an organopolysiloxane having at least two silicon-bonded ethylenically unsaturated groups per molecule;
(ii) an organohydrogensiloxane having at least two silicon-bonded hydrogen atoms per molecule;
(iii) a hydrosilylation catalyst;
(iv) optionally, a physical blowing agent when the silicone composition is to be made into a foam; and
(v) optionally, glass microspheres.

6. The method in accordance with claim 5, wherein the silicone composition can be cured to a silicone elastomeric material to form an encapsulating layer around a pipe when no physical blowing agent (iv) is present or can generate a foamed silicone elastomer.

7. The method in accordance with claim 5, wherein the physical blowing agent (iv) is selected from the group consisting of nitrogen gas, carbon dioxide gas, a solid tailored to undergo a phase change at or below the temperature of cure of the silicone composition, a liquid tailored to undergo a phase change at or below the temperature of cure of the silicone composition, and combinations thereof.

8. The method in accordance with claim 5, wherein the physical blowing agent (iv) is selected from one or more of: 1,1,1,3,3-pentafluoropropane (HFC-245fa), 1,1,1,3,3-pentafluorobutane (HFC-365mfc), 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, perfluorooctane, fluorobenzene, 1,2-difluorobenzene, 1,4-difluorobenzene, 1,3-difluorobenzene, 1,3,5-trifluorobenzene, 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene.

9. The method in accordance with claim 5, wherein the silicone composition comprises one or more additives selected from surfactants; stabilizers; adhesion promoters; colorants; antioxidants; carrier vehicles; heat stabilizers; flame retardants; thixotropic agents; flow control additives; inhibitors; and fillers.

10. The method in accordance with claim 1, wherein the silicone composition is supplied as a silicone foam and is prepared via a continuous process which comprises the steps of;
(a) blending a part A composition comprising components (i) one or more silicone polymers containing at least two alkenyl or alkynyl groups per molecule and (iii) a hydrosilylation catalyst and separately blending a part B composition comprising a further amount of component (i) and component (ii) an Si—H containing cross-linker;
(b) introducing the part A composition and the Part B composition into respective mixing containers and mixing;
(c) transferring resulting part A and part B mixtures of step (b) into respective pumping means;
(d) pumping the resulting part A and part B mixtures of steps (b) and (c) into a mixer unit and mixing to form a foam; and
(e) dispensing the resulting foam; wherein
(f) component (iv) a physical blowing agent is introduced into one or both of the part A composition or the part B composition during step (a) or step (b) and/or is introduced into the mixer unit during step (d).

11. The method in accordance with claim 10, wherein the physical blowing agent (iv) is added:
(1) completely into the part A blend during step (a); or
(2) completely into the part A composition during step (b); or
(3) completely into the part B blend during step (a); or
(4) completely into the part B composition during step (b); or
(5) partially into the part A blend and partially into the part B blend during step (a); or
(6) partially into the part A composition and partially into the part B composition during step (b); or
(7) completely directly into the mixer unit of step (d);
(8) partially into the part A blend during step (a) and partially directly into the mixer mixing unit of step (d); or
(9) partially into the part A composition during step (b) and partially directly into the mixer unit of step (d); or
(10) partially into the part B blend during step (a) and partially directly into the mixer mixing unit of step (d); or
(11) partially into the part B composition during step (b) and partially directly into the mixer unit of step (d); or
(12) partially into the part A blend, partially into the part B blend during step (a) and partially directly into the mixer unit of step (d); or
(13) partially into the part A blend and partially into the part B blend during step (a) and partially directly into the mixer unit of step (d); or
(14) partially into the part A composition, partially into the part B composition during step (b) and partially directly into the mixer unit of step (d); or
(15) partially into the part A composition and partially into the part B composition during step (b), and partially directly into the mixer unit of step (d).

12. The method in accordance with claim 10, wherein component (v) glass microspheres are present in the silicone composition and optionally,are introduced before step (d).

13. The A-method in accordance with claim 1, wherein monitors are provided to monitor one or more of temperature, pressure and/or flow rate and are designed to transmit a signal to a control unit:
(i) if a parameter strays outside a predefined range; and/or
(ii) to enable the control unit to be able to determine a suitable speed of withdrawal of the hose from the cavity; and/or
(iii) to allow the control unit to vary the supply of the silicone composition.
